(19) United States
(12) Patent Application Publication
(10) Pub. No.: US 2019/0212759 A1
(43) Pub. Date: Jul. 11, 2019

(54) System and Method of Networked Local Heating

(71) Applicant: OSRAM GmbH, Munich (DE)

(72) Inventors: Joseph J. Laski, Stoneham, MA (US); Nancy H. Chen, North Andover, MA (US)

(21) Appl. No.: 15/866,443

(22) Filed: Jan. 9, 2018

(51) Int. Cl. G05D 23/19; F24H 1/06; F24H 9/20; F24F 11/39; A47C 7/74; F24F 7/06

(52) U.S. Cl. CPC G05D 23/1917; F24H 1/06; F24H 9/2071; F24F 7/065; A47C 7/744; A47C 7/748; F24F 11/39

(57) ABSTRACT

A system of networked local heating includes a plurality of networked local heating sources, each networked local heating source including a directional infrared (IR) radiation heat source configured to output directional IR radiation toward a remotely located target area, and a local heat source controller configured to activate the directional IP radiation heat source to output the directional IR radiation toward the remotely located target area during short duration radiative heat events. The system also includes a local heat source management system configured to log heat event requests from each of the local heat source controllers.

### TECHNICAL FIELD

This present application relates to a system and method of networked local heating and more particularly to systems and methods of networked local heating for improving occupant comfort and gathering building data.

### BACKGROUND

Keeping building occupants comfortable is an ongoing task for facilities managers. Temperature related complaints, in certain circumstances, may present a large share of occupant complaints. Addressing these complaints to provide a comfortable ambient temperature is challenging, for example, due to different thermal preferences of different building occupants. Even for a single individual there may be a variation in thermal preference from season to season, day-to-day, or even within a day due to varying activity levels, clothing, illness, etc.

Clothing worn by modern office workforce also varies greatly, from classical business wear with long-sleeved shirt, jacket and pants, to sleeveless dresses during warmer seasons. Activities may also range from moderately active walking from meeting to meeting, to quite sedentary prolonged hours at a computer. It is difficult for the facility manager to keep track of the personal thermal preferences of the occupants, and all but impossible to be aware of fluctuating preferences through the course of the day, for example as may result from varying activity levels throughout the day.

Another challenge is that typical building HVAC systems provide insufficient spatial and temporal control of thermal conditions. Additionally, HVAC systems in office buildings typically deliver conditioned air in a relatively diffuse manner that is not always uniform, for example due to limited ventilation duct output points and air flow obstructions in the form of walls and furniture. Thermostats often control temperatures for an entire room or floor, which may not provide sufficient individualized regions within the building. Likewise, if the HVAC system is instructed to make a temperature change, the requested temperature change may take tens of minutes or hours to stabilize. Thus, even with complete and instantaneous knowledge of occupant thermal preferences, it may still be difficult to deliver the desired thermal conditions. Such is the case both in the heating months, and in the summer when office buildings tend to be over air conditioned.

### SUMMARY

All examples and features mentioned below may be combined in any technically possible way.

Various implementations disclosed herein include a system of networked local heating. The system includes a plurality of networked local heating sources, in which each networked local heating source includes a directional infrared (IR) radiation heat source configured to output directional IR radiation toward a remotely located target area and a local heat source controller configured to activate the directional IP radiation heat source to output the directional IR radiation toward the remotely located target area during short duration radiative heat events in response to heat event requests, and a local heat source management system configured to log heat event requests from each of the local heat source controllers.

In some embodiments, the local heat source management system is further configured to apply a quota to each of the plurality of networked local heating sources to prevent activation of each of the plurality of networked local heating sources more than the quota number of times during a given time interval. In some embodiments, the local heat source management system is further configured to send an instruction to a building control system to request an adjustment to an ambient temperature in a region encompassing a subset of the plurality of networked local heating sources when a number of heat event requests from the subset of networked local heating sources exceeds a threshold value. In some embodiments, the local heat source management system is further configured to correlate requests for activation of a subset of the plurality of networked local heating sources located within a region of an indoor environment with weather conditions outside of the indoor environment. In some embodiments, the local heat source management system is further configured to obtain information about anticipated or detected weather conditions outside of the indoor environment, and request an adjustment to an ambient temperature in the region encompassing the subset of networked local heating sources when a historical number of requests from the subset of networked local heating sources within the region exceeded a threshold value during previous periods of similar weather conditions.

In some embodiments, each of the plurality of networked local heating sources is configured to output a directional IR radiation beam pattern toward at least one respective target area. In some embodiments, one or more of the plurality of networked local heating sources are configured to steer the directional IR radiation beam pattern toward a plurality of respective target areas. In some embodiments, the system may further include a camera to obtain at least one image of the plurality of respective target areas, and each of the one or more networked local heating sources is configured to use the at least one image to determine which of the respective target areas is occupied by a person and to steer the directional IR radiation beam pattern toward the respective target areas that are occupied by the person.

In some embodiments, the system further includes a camera to obtain an image of a first target area associated with a first networked local heating source, and the local heat source management system is further configured to detect whether a person is present in the first target area based on the image, and control the first networked local heating source based on whether the person is present in the first target area. In some embodiments, one or more of the plurality of networked local heating sources further includes at least one of a communication module, a power control module, an IR radiation source, and an IR radiation focusing system. In some embodiments, the communication module is configured to communicate with the local heat source controller and the local heat source management system via one or more wireless communication networks. In some embodiments, the power control module selectively supplies power to the directional IR radiation heat source under the control of the communication module. In some embodiments, the directional IR radiation heat source is ceiling mounted. In some embodiments, a user inputs the heat event request to the local heat source controller.

Further implementations disclosed herein includes a method of networked local heating. The method includes receiving, at a networked local heating source, a request to activate the networked local heating source, in which the networked local heating source includes an infrared (IR) radiation heat source that is controllable by a local heat source controller to output IR radiation during short duration heat events, communicating, by the networked local heating source, information about the request to a local heat source management system configured to log heat event requests from the local heat source controller, and activating, by the networked local heating source in response to the request, the IR radiation heat source to provide a directional IR radiation beam pattern toward a remotely located target area in an indoor environment.

In some embodiments, the method further includes applying a quota, by the local heat source management system, to prevent activation of the networked local heating source more than the quota number of times during a given time interval. In some embodiments, the method further includes sending an instruction, by the local heat source management system to a building control system, to request an adjustment to an ambient temperature in a region encompassing the networked local heating source when a number of requests from a plurality of networked local heating sources within the region exceeds a threshold value. In some embodiments, the method further includes correlating, by the local heat source management system, requests for activation of a set of networked local heating sources located within a region of the indoor environment with weather conditions outside of the indoor environment. In some embodiments, the method further includes obtaining, by the local heat source management system, information about anticipated or detected weather conditions outside of the indoor environment, and requesting, by the local heat source management system, an adjustment to an ambient temperature in the region encompassing the set of networked local heating sources when a historical number of requests from the set of networked local heating sources within the region exceeded a threshold value during previous periods of similar weather conditions. In some embodiments, activating the IR radiation heat source includes outputting directional IR radiation at a first constant level for a first period of time and then ramping down a power level of the directional IR radiation over a second period of time.

### BRIEF DESCRIPTION OF THE DRAWINGS

FIG. 1 is a floor plan diagram of an example workspace in a building, in which a system of networked local heating is deployed in accordance with some embodiments of the present disclosure.

FIGS. 2 and 3 are block diagrams illustrating example methods of providing local heating in accordance with some embodiments of the present disclosure.

FIG. 4 is a functional block diagram of a network of local heating sources in accordance with some embodiments of the present disclosure.

FIG. 5 is a floor plan diagram of an example workspace 100 in which a plurality of networked local heating sources 110 are deployed in accordance with some embodiments of the present disclosure.

FIGS. 6-7 are functional block diagrams of example networked local heating sources in accordance with some embodiments of the present disclosure.

FIGS. 8-10 are lane diagrams showing the transmission of information between components of an example system of networked local heating, in accordance with some embodiments of the present disclosure.

FIGS. 11A-11C are example power output profiles of an example networked local heating source in accordance with some embodiments of the present disclosure.

FIGS. 12-14 are flow charts of example methods of networked local heating in accordance with some embodiments of the present disclosure.

FIG. 15 is an electrical circuit diagram of an example system of networked local heating in accordance with some embodiments of the present disclosure.

FIG. 16 is a flow chart of an example method of networked local heating in accordance with some embodiments of the present disclosure.

FIG. 17 is an example database entry in accordance with some embodiments of the present disclosure.

These and other features of the present embodiments will be understood better by reading the following detailed description, taken together with the figures herein described. In the drawings, each identical or nearly identical component that is illustrated in various figures may be represented by a like numeral. For purposes of clarity, not every component may be labeled in every drawing.

### DETAILED DESCRIPTION

This disclosure is based, at least in part, on the realization that it would be advantageous to provide a system and method of networked local heating. Numerous configurations and variations will be apparent in light of this disclosure.

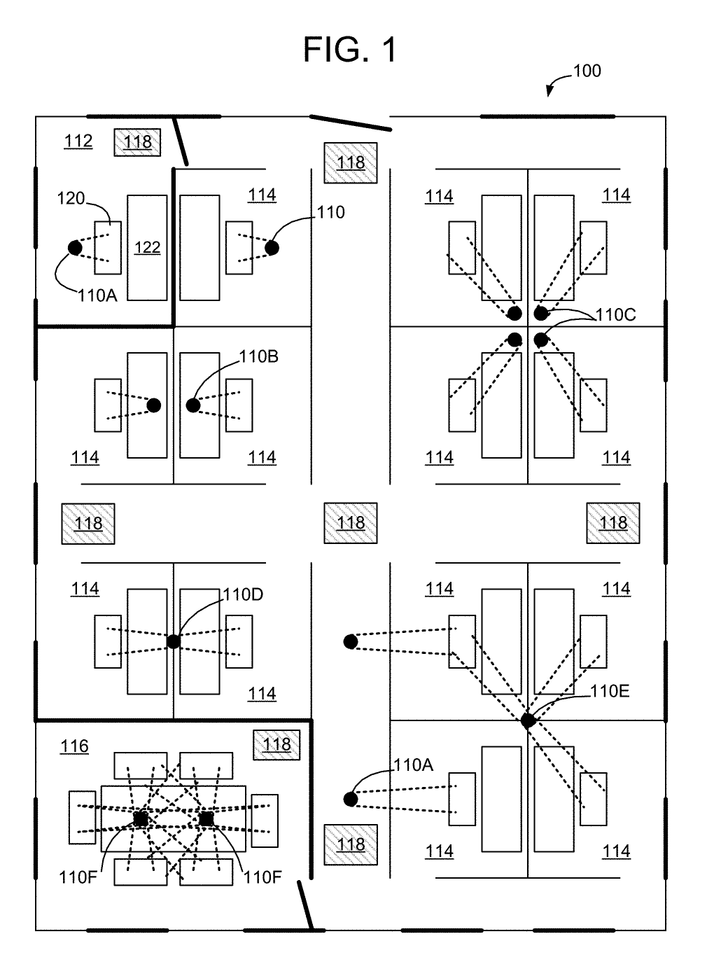

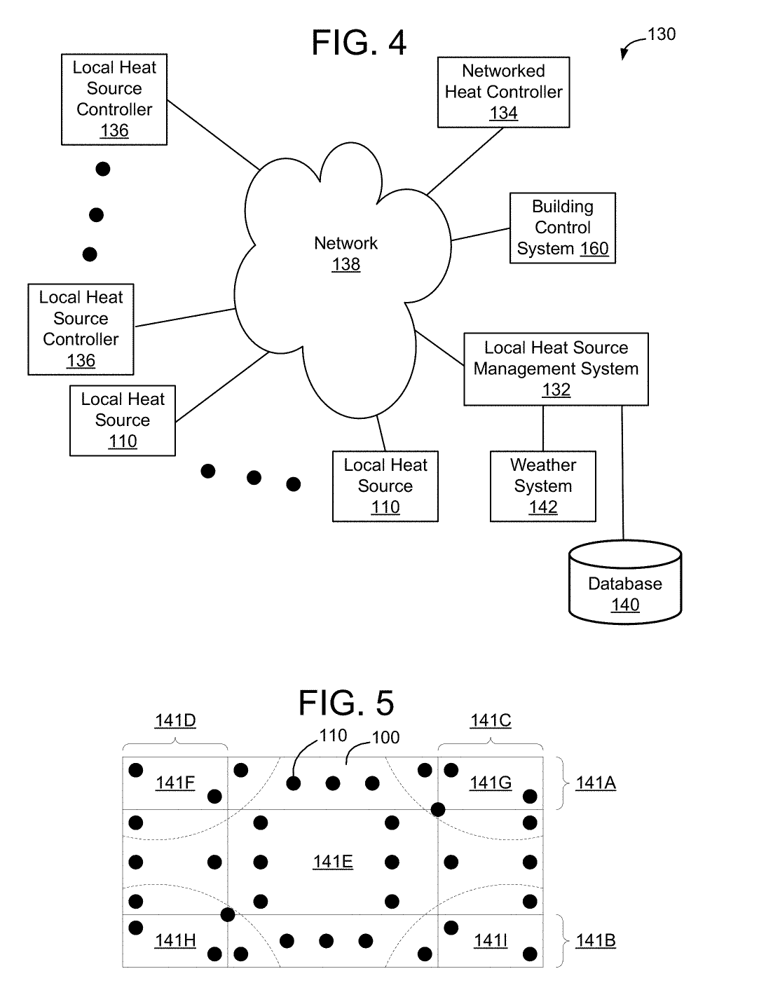

FIG. 1 is a floor plan diagram of an example workspace 100 in which a plurality of networked local heating sources 110 are deployed, in accordance with some embodiments of the present disclosure. In the example workspace 100 shown in FIG. 1, the example workspace 100 includes an individual office 112, a plurality of cubicles 114, and a conference room 116. Duct outlets 118 are dispersed throughout the workspace 100. A Heating, Ventilation, and Air Conditioning (HVAC) system (not shown) provides conditioned air to the workspace through the duct outlets 118 to control the overall ambient temperature of the workspace 100. In some embodiments, duct outlets 118 may be individually controlled to output more or less heat or cooling as specified by a building control system 160 (see FIG. 4). In some embodiments, networked local heating sources 110 provide heat to individual areas of the workspace 100 on demand, as requested by occupants of the individual areas.

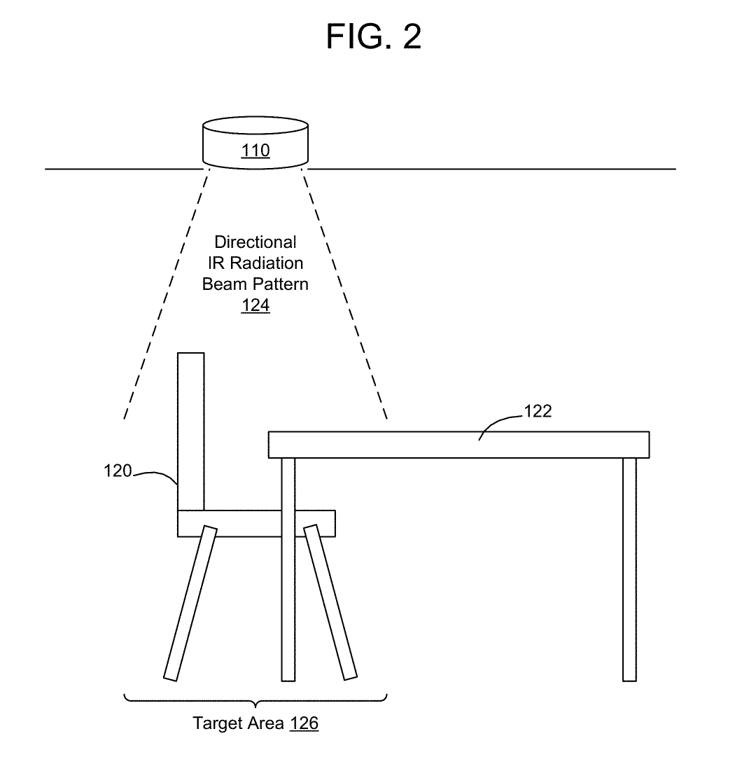

In some embodiments, each networked local heating source 110 outputs infrared radiation (IR) in a directional IR radiation beam pattern 124 to encompass a small area (target area 126) within the workspace 100, as illustrated in FIG. 2 by the dashed lines emanating from the networked local heating sources 110. If a person (occupant) is situated within the target area 126 of the directional IR radiation beam pattern 124, the output IR radiation is felt as heat by the occupant to thereby provide temporary warmth to the occupant.

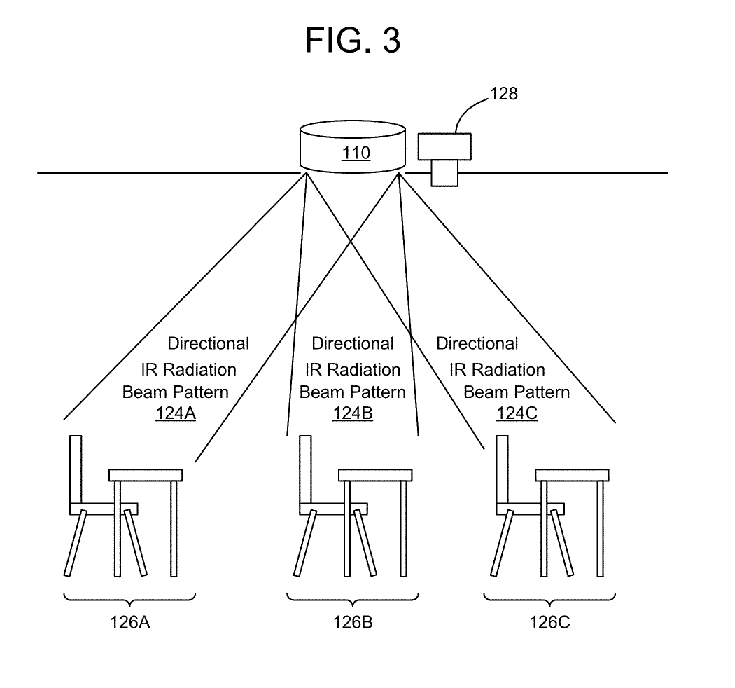

In some embodiments, the networked local heating sources 110 provide directional IR radiation heat from ceiling fixtures as shown in FIGS. 2 and 3. In other embodiments, the networked local heating sources 110 may be wall mounted or located in other locations spatially separated from respective target areas 126 to provide IR radiation to warm occupants of the target areas 126. For example, the networked local heating sources 110 in some embodiments may be mounted on a cubicle wall, office wall, filing cabinet, desk privacy panel, computer monitor mount arm, or other conveniently located place to provide directional IR heat to an occupant of a target area 126.

The location of the networked local heating sources 110 relative to the target areas 126 may vary. For example, in FIG. 1 networked local heating source 110A has been adjusted to output IR radiation in a directional IR radiation beam pattern 124 to form a target area 126 encompassing a chair 120 situated at a desk 122. The networked local heating source 110A, in FIG. 1, is shown as having been installed behind the chair 120 if the chair 120 is facing the desk 122, to provide directional IR radiation to an occupant of the chair 120 from behind when the occupant is facing the desk 122.

Networked local heating source 110B is situated in front of a chair 120/desk 122 combination and has been adjusted to output IR radiation in a directional IR radiation beam pattern 124 to form a target area 126 encompassing the chair 120. Since the networked local heating source 110B is situated in front of the chair 120 if the chair 120 is facing the desk 122, networked local heating source 110B provides directional IR radiation to an occupant of the chair 120 from the front when the occupant is facing the desk 122.

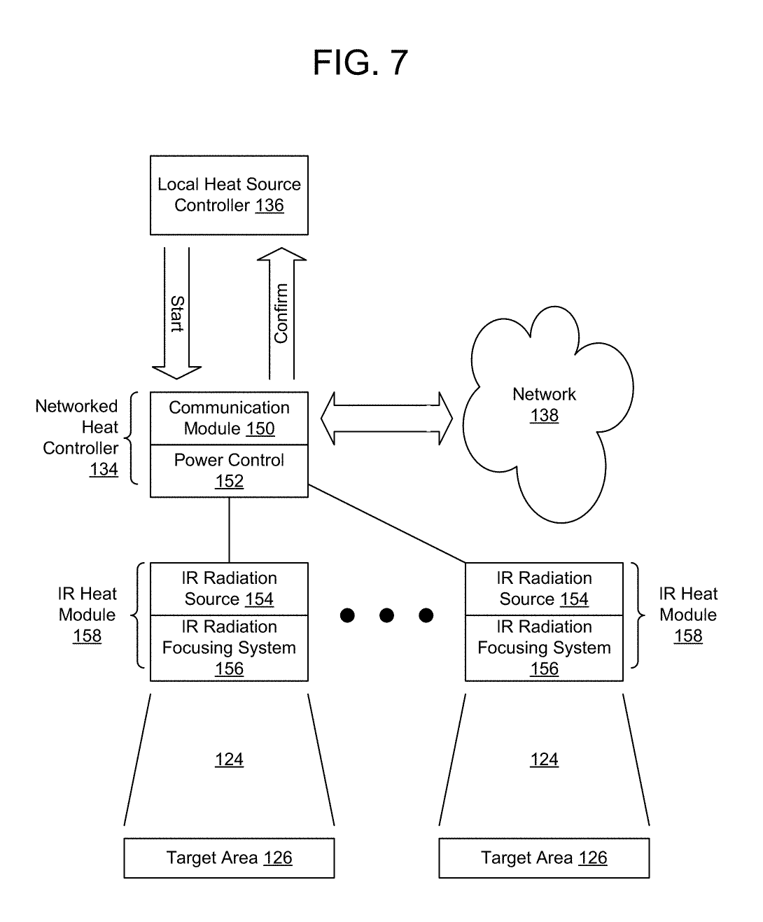

Networked local heating sources 110C are arranged in a cluster to provide directional IR radiation toward a set of target areas 126 within a group of cubicles 114. Clustering networked local heating sources 110 may facilitate installation and optionally may also enable the networked local heating sources 110 to share resources, such as network communication capabilities and power supply components, as described in greater detail below in connection with FIG. 7.

Networked local heating source 110D is configured to provide directional IR radiation toward multiple target areas 126. The networked local heating source 110D may dynamically optically steer directional IR radiation toward a first (left) target area 126 or toward a second (right) target area 126 depending on which occupant requested activation of the networked local heating source 110D. Additional details related to dynamic directional IR radiation beam steering is set forth below. Similarly, networked local heating source 110E is configured to dynamically optically steer directional IR radiation toward target areas 126 within a group of cubicles 114.

Networked local heating sources 110F, in conference room 116, are configured to cooperatively provide directional IR radiation toward multiple target areas 126. In FIG. 1, each of the networked local heating sources 110F is able to provide directional IR radiation to a plurality of shared target areas 126. This enables occupants of the shared target areas 126 to request output of IR radiation and receive output IR radiation from any available networked local heating source 110F. Thus, rather than having the left local heating source 110F be responsible for outputting IR radiation to the three target areas 126 on the left side of the conference room 116, and having the right local heating source 110F be responsible for outputting IR radiation to the three target areas 126 on the right side of the conference room 116, each networked local heating source 110F may output IR radiation to any target area 126 within the conference room 116.

FIGS. 2 and 3 are block diagrams illustrating example methods of providing local heating in accordance with some embodiments of the present disclosure. As shown in FIG. 2, in some embodiments, a networked local heating source 110 is configured to output IR radiation in a directional IR radiation beam pattern 124. Outputting IR radiation in this manner causes IR radiation to be incident on any object located within a target area 126. For example, in FIG. 2 a chair 120 is shown within the target area 126. Thus, if a person were sitting on the chair, the incident IR radiation would be perceived as heat to temporarily warm the occupant of the chair. A person is not required to sit to receive the benefit of the output IR radiation of the networked local heating source 110 however, because an occupant of the target area 126 obtains the effect of the output IR radiation regardless of whether they are sitting, standing, or lying down. Likewise, as shown in FIG. 2, the target area 126 in this example includes a portion of desk 122 which means that the output IR radiation is incident on a user's hands, if the user is typing on a keyboard or laptop computer that is located within the target area 126. Hence, depending on the location and size of the target area, people with chronically cold hands or other body parts may receive warming IR radiation directly to their hands or selected body parts to provide temporary localized warmth.

FIG. 3 shows an example in which the networked local heating source 110 is configured to output directional IR radiation beam patterns 124 in multiple directions. Specifically, the networked local heating source 110, in some embodiments, selectively outputs directional IR radiation beam pattern #1 124A to supply IR radiation to target area #1 126A, selectively outputs directional IR radiation beam pattern #2 124B to supply IR radiation to target area #2 126B, and/or selectively outputs directional IR radiation beam pattern #3 124C to supply IR radiation to target area #3 126C. The networked local heating source 110 may output IR radiation to form one directional IR radiation beam pattern 124 at a time or, optionally, may output IR radiation to form multiple directional IR radiation beam patterns 124 at once.

Optionally, as shown in FIG. 3, a camera 128 may monitor the environment surrounding the networked local heating source 110 to detect movement of an occupant of one of the target areas 126 that requested activation of the networked local heating source 110. As the occupant moves about the environment, the directional IR radiation beam pattern associated with the initial target area 126 may be steered to continue focus on the original occupant to dynamically cause the target area 126 to follow the original occupant within the workspace 100. Alternatively, if the camera 128 detects that the occupant has left the target area 126, the networked local heating source 110 may be turned off to conserve energy. Although some embodiments make use of a camera to monitor the target area to detect movement of the occupant from the target area, in other embodiments other external monitoring systems may alternatively be used. Example external monitoring systems may include passive infrared detectors, vibration sensors, seat cushion sensors, and other similar sensors configured to detect when the target area is not occupied. When the target area is not occupied, the networked local heating source 110 may be turned off to conserve energy.

FIG. 4 is a functional block diagram of a network of local heating sources in accordance with some embodiments of the present disclosure. As shown in FIG. 4, in some embodiments, a system of networked local heating 130 includes a plurality of networked local heating sources 110 and a local heat source management system 132. Optionally, as described below, if one or more of the networked local heating sources 110 does not have network communication capabilities, the system of networked local heating 130 may also include one or more networked heat controllers 134 to selectively activate such networked local heating sources 110.

Local heat source controllers 136 are provided to enable people to selectively activate local heat sources 110. In some embodiments, local heat source controllers 136 communicate directly with the networked local heating sources 110 to activate the networked local heating sources 110. In some embodiments, local heat source controllers 136 communicate with another component of the system of networked local heating 130, such as with the networked heat controller 134 or with the local heat source management system 132.

In some embodiments, the local heat source controllers 136 are wireless devices configured to communicate using a wireless communication protocol, such as via ZigBee, Bluetooth, or on a wireless local area network. In some embodiments, the local heat source controllers 136 are configured to communicate using a cellular communication protocol. In some embodiments, the local heat source controllers 136 are configured to communicate on a wired network such as an Ethernet network. In some embodiments, one or more of the local heat source controllers 136 are implemented as applications on a desktop computer, laptop computer, smartphone, or other electronic device. In some embodiments, the local heat source controllers 136 are implemented as a local heat source remote control device having a button that is pressed to request activation of a specific associated networked local heating sources 110.

The term “system of networked local heating 130” as used herein, includes networked local heating sources 110, local heat source management system 132, and optionally networked heat controllers 134. Local heat source controllers 136 are used to interact with and control operation of the system of networked local heating 130, but are not part of the “system of networked local heating 130” unless specifically configured to only interact with and control operation of the system of networked local heating 130. The components of the system of networked local heating 130 communicates via network 138. In embodiments in which a separate wireless or wired network 138 is deployed specifically to enable the components of the system of networked local heating 130 to communicate with each other, the network 138 may be considered to be a component of the “system of networked local heating 130” as that term is used herein. In embodiments in which the network 138 is used for other purposes, such as for example where the network 138 is a Local Area Network (LAN) used for general purpose communication within workspace 100, and communication between the components of the system of networked local heating 130 simply use the network 138 for communication purposes, then the network 138 is not considered to be a component of the “system of networked local heating 130” as that term is used herein.

In some embodiments, the local heat source management system 132 maintains a database 140. An example database entry illustrating an example of the type of information that may be maintained in database 140 is discussed in greater detail below in connection with FIG. 17. The database 140, in some embodiments, is populated with location information within workspace 100 of the networked local heating sources 110 and target areas 126. In some embodiments, each networked local heating source 110 has an identifier and is associated with one or more identified target areas 126. The database also includes a log recording timing of local heat request events.

In some implementations groups of networked local heating sources 110 are also identified within the database 140 to enable correlation between activation of networked local heating sources 110 and areas or regions of workspace 100.

For example, as shown in FIG. 5, networked local heating sources in different areas of workspace 100 may be grouped in regions 141. In FIG. 5, region 141A is on the north side of the workspace 100, region 141B is the south side of the workspace 100, region 141C is the east side of the workspace, region 141D is the west side of the workspace, region 141E is the center of the workspace, region 141F is the northwest corner of the workspace, region 141G is the northeast corner of the workspace, region 141H is the southwest corner of the workspace, and region 141I is the southeast corner of the workspace.

Creating regions 141 based on cardinal orientation of the networked local heating source 110 enables correlation between activation of networked local heating sources 110 in those regions 141 with weather events obtained from a weather system 142, as discussed in greater detail below in connection with FIG. 14. As shown in FIG. 5, in some embodiments, it is possible for a given networked local heating source 110 to be included in multiple regions 141. In other embodiments, a given networked local heating source 110 is included in only one region 141. In other embodiments, the networked local heating sources 110 are grouped into regions 141 based on the location of the target area 126 rather than based on the location of the networked local heating source 110.

Other criteria may be used to define regions 141 as well. For example, functional areas of the workspace 100 may be used, for example by creating a group of networked local heating sources 110 within the HR department or creating a group of all networked local heating sources 110 within a conference room. As another example, a region 141 may be defined by identifying all networked local heating sources 110 within a heating zone of an HVAC system. Other groupings may be used as well. Assignment of a networked local heating source 110 to one or more regions 141 may occur once upon commissioning of the system, or may be done more frequently to optimize use of the data available to the local heat source management system 132.

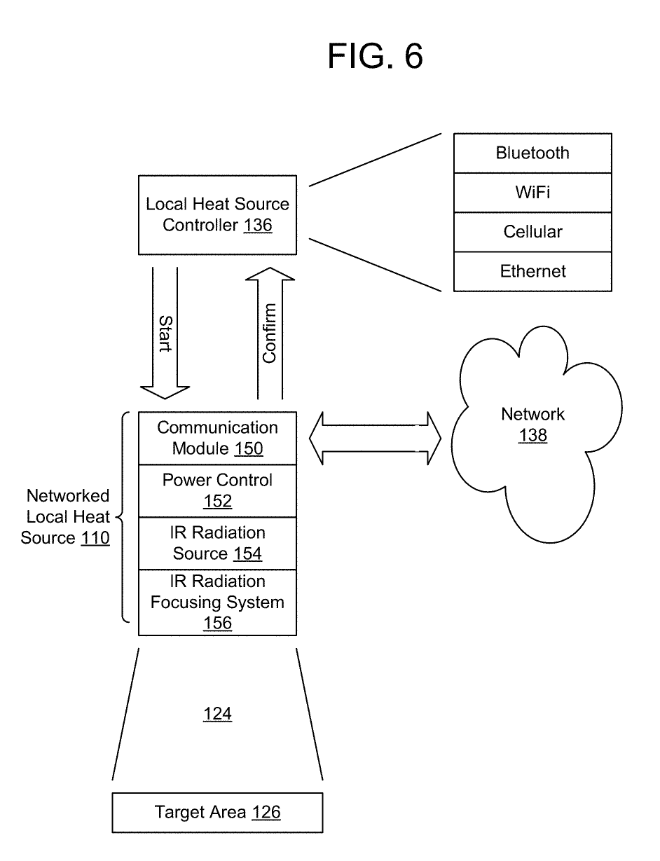

FIGS. 6-7 are functional block diagrams of example networked local heating sources 110 in accordance with some embodiments of the present disclosure. As shown in FIG. 6, a networked local heating source 110 includes a communication module 150, a power control 152, an IR radiation source 154, and an IR radiation focusing system 156.

The communication module 150 receives communication (referred to herein as a “local heat request event”) from local heat source controller 136, and optionally communicates back to local heat source controller 136. For example, communication module 150 may receive a first communication message containing an instruction to activate networked local heating source 110 and may transmit a second communication message confirming receipt of the message. The confirmation may be a confirmation that activation will commence immediately, that activation has been denied, or that activation will occur within a specified time-period. Other confirmation messages may be used as well. The communication module 150 also communicates via network 138, for example with local heat source management system 132.

Power control 152 turns on/off IR radiation source 154 under the direction of communication module 150. In an implementation in which an intensity of the IR radiation output by the networked local heating source 110 is intended to vary over time, power control 152 adjusts the power characteristics applied to the IR radiation source 154 to adjust the amount of IR radiation generated by the IR radiation source 154 over time. The amount of power may also be specified remotely and actuated by sending closely spaced but separate commands in succession to the power control 152 to cause the power control 152 to adjust the power characteristics applied to the IR radiation source 154 to adjust the amount of IR radiation generated by the IR radiation source 154 over time. IR radiation focusing system 156 focuses IR radiation generated by IR radiation source 154 onto target area 126.

In some implementations IR radiation source 154 is a radiative heat source. Radiative heat sources allow highly localized delivery of heat at a remote target. For example, IR radiation emission from the incandescent filament of a ceiling-mounted flood light may be directed by parabolic optics into a relatively narrow directional IR radiation beam pattern 124 toward a target area 126, for example including an occupant seated at a desk 122 below the ceiling-mounted flood light. It is possible, for example, to operate an incandescent or halogen lamp at a power level that allows a tuning of the ratio of visible and IR radiation output by the ceiling-mounted flood light. The amount of control on the spread characteristics of the directional IR radiation beam pattern 124 depends on the distance between the IR radiation source 154 and the target area 126. Likewise, IR emitting LEDs may be used to generate IR radiation to form the directional IR radiation beam pattern 124. By forming IR emitting LEDs on the inside surface of a concave shaped luminaire, and selectively turning on groups of LEDs in sectors of the concave shape, electronically steerable IR radiation beam may be generated.

In some embodiments, the infrared emission of IR radiation source 154 is supplemented with visible emission to make its appearance more like that of ambient lighting luminaires nearby. Supplemental visible emission may also be used as a signal that the heat source is on, providing effective psychological reinforcement instead of or in addition to communication of the second communication message from the communication module 150 to the local heat source controller 136 confirming receipt of the request for activation of the networked local heating source 110.

Near infrared light, having a wavelength in the 760-2000 nm (nanometer) range, possesses optical properties very similar to normal light, including the ability to be reflected, refracted, and to pass through optically clear objects. Accordingly, depending on the implementation, IR radiation focusing system 156 may include one or more optical components such as mirrors, waveguides, and optical lenses, to focus and direct IR radiation generated by IR radiation source 154 to help form an intended directional IR radiation beam pattern 124. Physically moving one or more of the optical components, for example reorienting a mirror, may adjust the directional IR radiation beam pattern 124 to be redirected from a first target area 126 to a second target area 126. Likewise, a networked local heating source 110 may have multiple individual IR radiation heat sources 154 that may be separately controlled and turned on/off to change the direction of the output directional IR radiation beam pattern 124.

FIG. 7 illustrates another example networked local heating source 110 in accordance with some embodiments of the present disclosure. FIG. 7 is similar to FIG. 6, except that communication module 150 and optionally power control 152 are separated from IR radiation source 154 and IR radiation focusing system 156. In particular, the communication and power control functions have been implemented in the networked heat controller 134 in FIG. 7, while IR radiation generation and IR radiation focusing functions are implemented separately in IR heat module 158. As shown in FIG. 7, in some embodiments, a given networked heat controller 134 may control operation of one or more than one IR heat module 158.

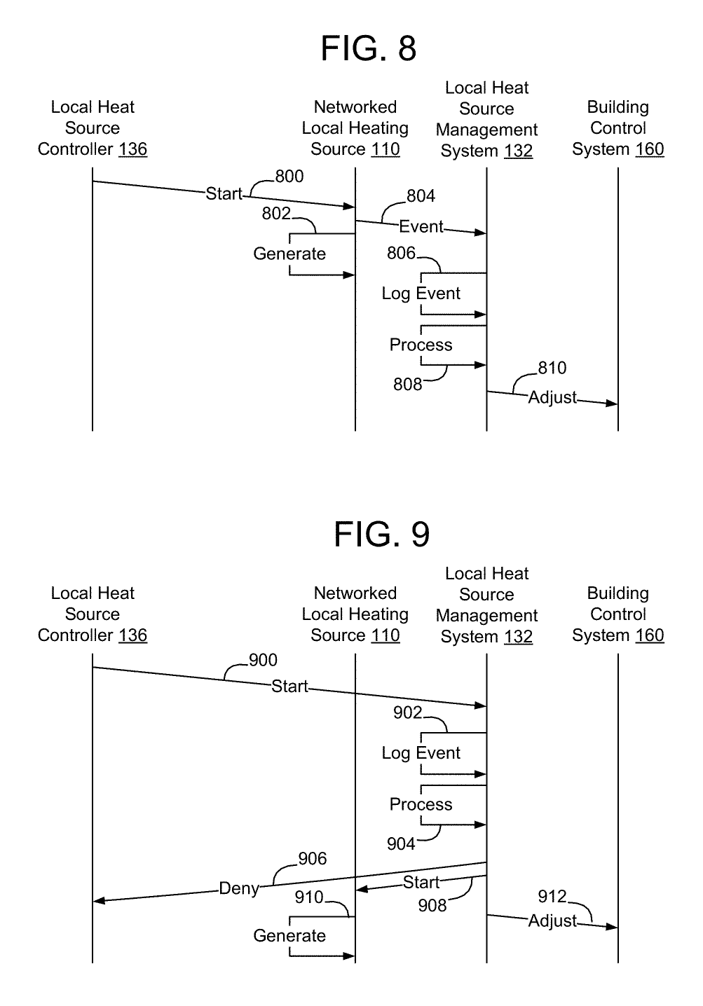

FIGS. 8-10 are lane diagrams showing the transmission of information between components of an example system of networked local heating 130, in accordance with some embodiments of the present disclosure.

In FIG. 8, the local heat source controller 136 transmits a START signal 800 to networked local heating source 110. In response, the networked local heating source 110 is activated to generate IR radiation 802. Prior to generating IR radiation, while generating IR radiation, or after generating IR radiation, the networked local heating source 110 transmits an EVENT signal 804 to local heat source management system 132. The local heat source management system 132 logs the event 806 to record the time of the event and which networked local heating source 110 generated the event. In embodiments where the networked local heating source 110 is able to focus IR radiation on multiple target areas 126, the identity of the target area 126 may also be stored. Information logged by local heat source management system 132 is stored in database 140. The local heat source management system 132 also optionally may process the event 808 to determine, for example, which region(s) 141 the networked local heating source 110 is associated with, and to determine, for example, whether other networked local heating sources 110 within the region 141 have also been activated within a previous time frame. If processing 808 determines that a sufficient number of events have occurred within a region 141, the local heat source management system 132 optionally sends an ADJUST instruction 810 to a building control system 160 to instruct the building control system 160 to adjust the ambient heat in the region 141 by adjustment of the HVAC output levels in that area. Where duct outlets 118 are individually controllable, the adjustment of the HVAC output may be implemented by adjusting the duct outlets 118 in the region 141.

FIG. 9 shows some embodiments in which the local heat source controller 136 transmits a START signal 900 to local heat source management system 132 instead of transmitting the START signal to the networked local heating source 110. Although FIG. 9 shows the START signal 900 being transmitted directly to the local heat source management system 132, optionally the START signal 900 may be transmitted to the networked local heating source 110 and forwarded by the networked local heating source 110 to the local heat source management system 132.

The local heat source management system 132 logs the event 902 to record the time of the event and which networked local heating source 110 generated the event. In some embodiments, when the START signal 900 is received, the local heat source management system 132 automatically transmits a START signal 908 to the networked local heating source 110 to cause the networked local heating source 110 to be activated to generate IR radiation 910.

In some embodiments, when the START signal 900 is received, the local heat source management system 132 processes the event 904 to determine how many events the networked local heating source 110 has generated within a predetermined preceding time period. If the networked local heating source 110 has generated more than a quota number of events within a predetermined preceding time period, the local heat source management system 132 transmits a DENY message 906 to the local heat source controller 136 and does not transmit START message 908. In this manner, the local heat source management system 132 may prevent overuse of particular networked local heating sources 110.

Similar to the embodiments shown in FIG. 8, the local heat source management system 132 also optionally processes the event 904 to determine, for example, which region(s) 141 the networked local heating source 110 is associated with, and to determine, for example, whether other networked local heating sources 110 within the region 141 have also been activated within a previous time frame. If processing 904 determines that a sufficient number of events have occurred within a region 141, the local heat source management system 132 optionally sends an ADJUST instruction 912 to a building control system 160 to instruct the building control system 160 to adjust the ambient heat in the region 141 by adjustment of the HVAC output levels in that area.

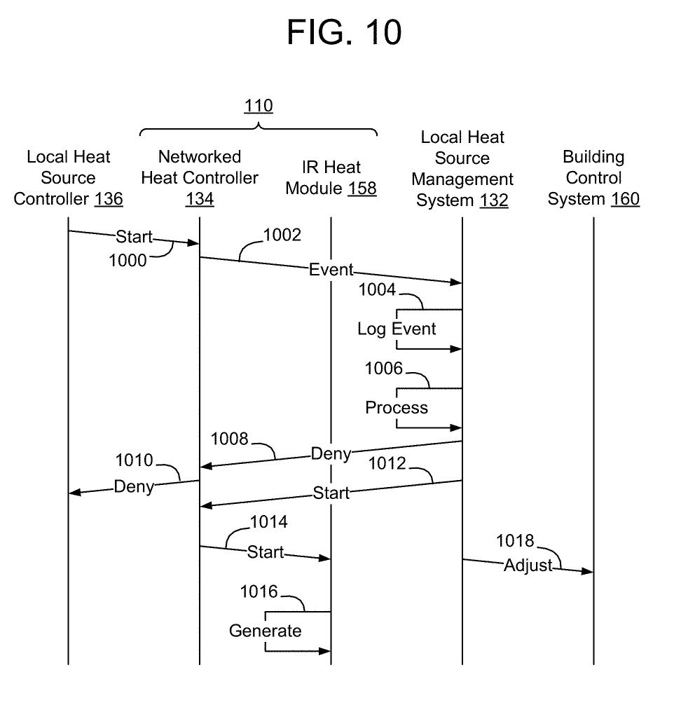

FIG. 10 shows embodiments in which the local heat source controller 136 transmits a START signal 1000 to networked heat controller 134 instead of transmitting the START signal to the networked local heating source 110. Upon receipt of the START signal 100, networked heat controller 134 transmits EVENT signal 1002 to local heat source management system 132. Although FIG. 10 shows the START signal 1000 being transmitted from the local heat source controller 136 to the networked heat controller 134, alternatively the START signal 1000 may be transmitted from the local heat source controller 136 directly to the local heat source management system 132.

The local heat source management system 132 logs the event 1004 to record the time of the event and which networked local heating source 110 generated the event. In some embodiments, when the START signal 1000 or EVENT signal 1002 is received, the local heat source management system 132 automatically transmits a START signal 1012 to the networked heat controller 134. Upon receipt of the START signal 1012, the networked heat controller 134 instructs power module 152 to initiate IR radiation source 154 (see FIG. 7). For convenience this is shown in FIG. 10 as transmission of a START signal 1014 to cause the IR heat module 158 to generate IR radiation 1016.

In some embodiments, when the START signal 1000 or event signal 1002 is received, the local heat source management system 132 processes the event 1006 to determine how many events the networked local heating source 110 has generated within a predetermined preceding time period. If the networked local heating source 110 has generated more than a quota number of events within a predetermined preceding time period, the local heat source management system 132 transmits a DENY message 1008 to the networked heat controller 134. The networked heat controller 134, in some implementations, transmits a DENY message 1010 to the local heat source controller 136 to enable the local heat source controller 136 to know that the request for local heat has been denied. When the local heat source management system 132 denies the request for local heat, the networked heat controller 134 does not transmit START message 1014 or activate power control 152 to prevent networked local heating source 110 from generating heat. In this manner, the local heat source management system 132 may prevent overuse of particular networked local heating sources 110.

Similar to the embodiments shown in FIG. 8, the local heat source management system 132 also optionally processes the event 1006 to determine, for example, which region(s) 141 the networked local heating source 110 is associated with, and to determine, for example, whether other networked local heating sources 110 within the region 141 have also been activated within a previous time frame. If processing 1006 determines that a sufficient number of events have occurred within a region 141, the local heat source management system 132 optionally sends an ADJUST instruction 1018 to a building control system 160 to instruct the building control system 160 to adjust the ambient heat in the region 141 by adjustment of the HVAC output levels in that area.

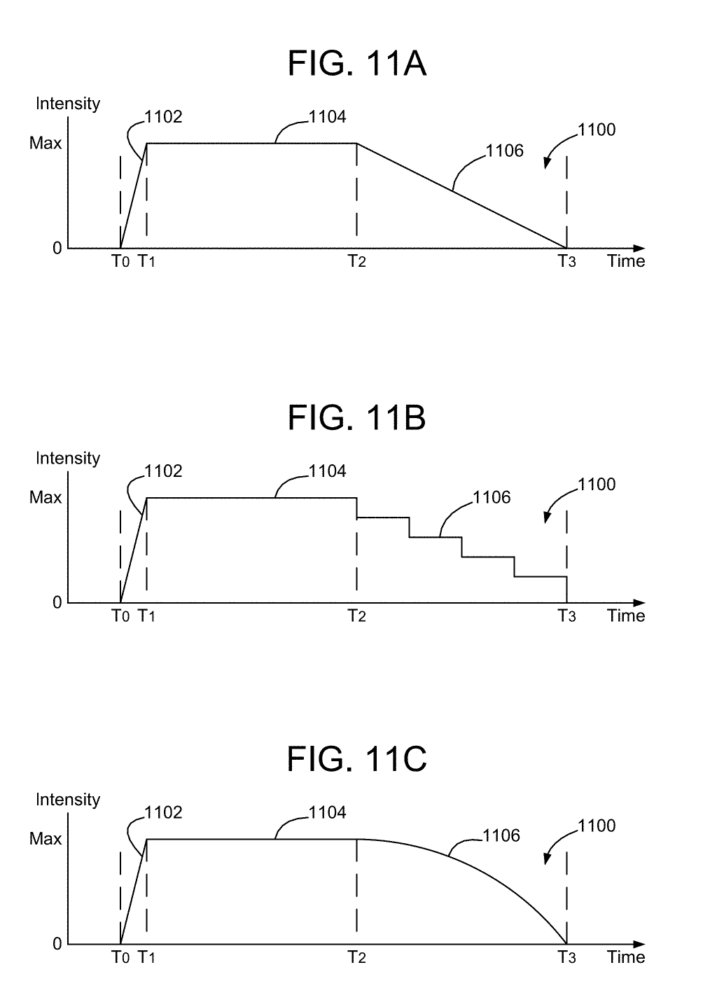

FIGS. 11A-11C illustrate an example power output profile 1100 of an example networked local heating source 110 in accordance with some embodiments of the present disclosure. As shown in FIG. 11A, when a determination is made to activate a networked local heating source 110, the power output of the networked local heating source 110 quickly ramps up during an initial turn-on period 1102 between time T₀ and time T₁. After the initial turn-on period 1102, the power output of the networked local heating source 110 is maintained in a steady state 1104 from time T₁ to time T₂. After time T₂, power is ramped down during a cool-off period 1106 until at time T₃ the power output reaches zero.

Many alternate power output profiles may be used. For example, as shown in FIG. 11B, instead of using a relatively constant tapering of output power during the cool-off period 1106, a step-wise function may be used to set the output power at successively lower discrete output power levels. Likewise, as shown in FIG. 11C, the power may be reduced non-linearly during the cool-off period 1106. Other power output profiles may be used depending on the implementation.

In some embodiments, the stead state period 1104 from time T₁ to time T₂ is on the order of 5 minutes, and the cool-off period 1106 is likewise on the order of 5 minutes. In other embodiments, the entire heating cycle time period (from time T₀ to time T₃) is on the order of 5 minutes. The selected length of the heating cycle depends on the particular implementation.

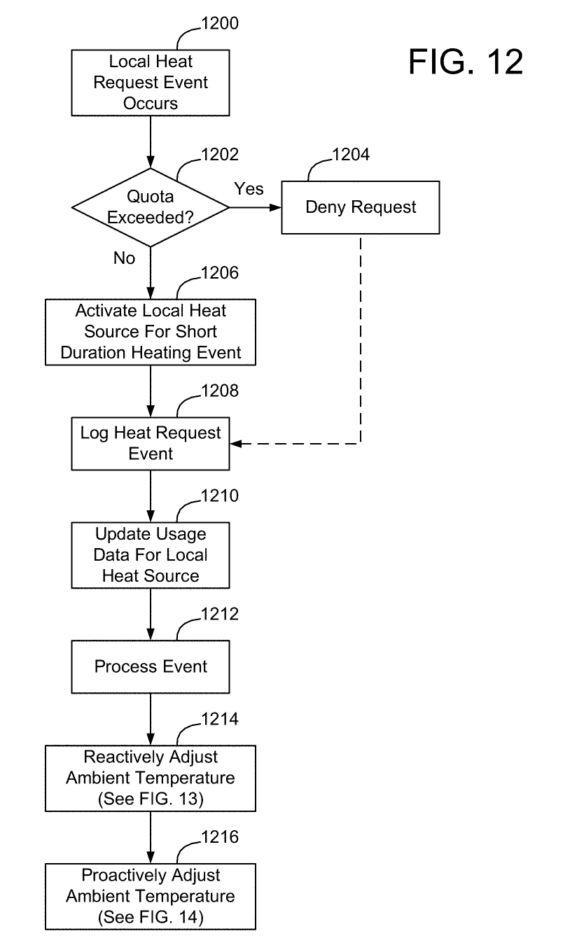

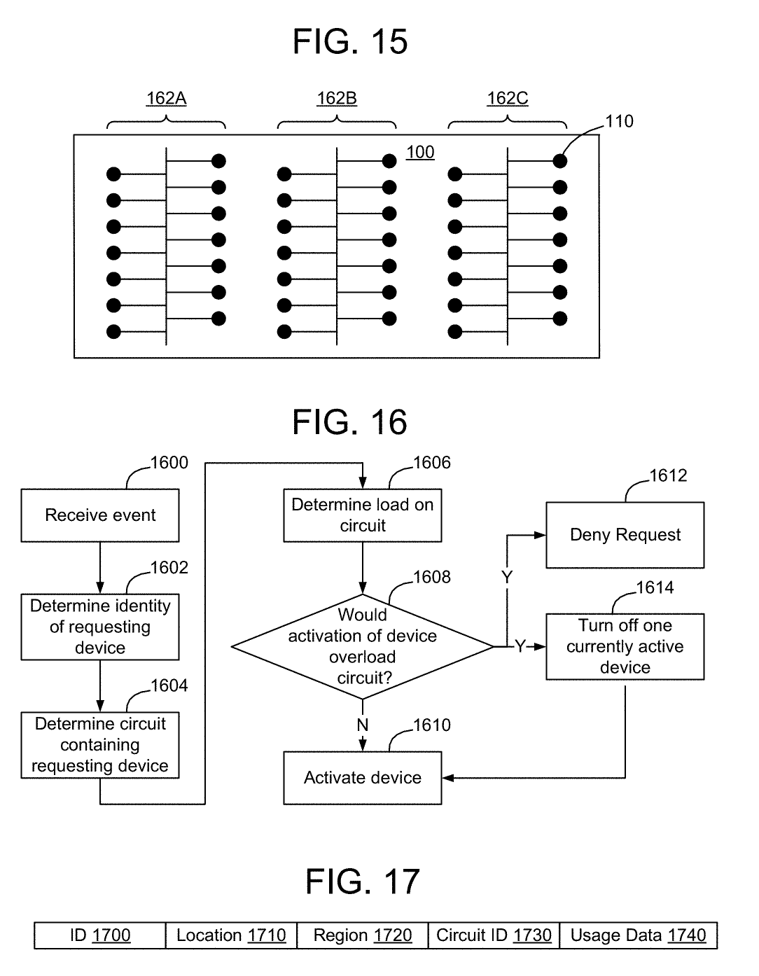

FIGS. 12-14 are flow charts of an example method of networked local heating in accordance with some embodiments of the present disclosure. The method may be performed by a system of networked local heating, which may include one or more networked local heating sources 110, local heat source management system 132, and optionally networked heat controllers 134. As shown in FIG. 12, the process starts with the occurrence of a local heat request event in block 1200. A determination is then made as to whether a local heat quota for the networked local heating source 110 has been exceeded in block 1202. If the request exceeds the local heat quota for the networked local heating source 110 (e.g. a determination of “yes” in block 1202), the local heat request event is denied in block 1204. Optionally the local heat request event may be logged in block 1208 even if it is denied, for use in calculating metrics relative to how well the HVAC system is working to provide a comfortable environment. Optionally, the quota check in block 1202 may also determine if activation of the networked local heating source 110 would overload a circuit based on the current state of other networked local heating sources 110 that share the same circuit, as described in greater detail below in connection with FIGS. 15 and 17.

If the local heat quota for the networked local heating source 110 has not been exceeded and activation of the networked local heating source 110 is otherwise possible (e.g. a determination of “no” in block 1202) the networked local heating source 110 is activated for a short duration heating event in block 1206. The local heat request event is also logged in block 1208 and usage data for the networked local heating source 110 is updated in block 1210. The usage data is used in block 1202 in connection with determining whether subsequent local heat request events exceed the quota for the networked local heating source 110.

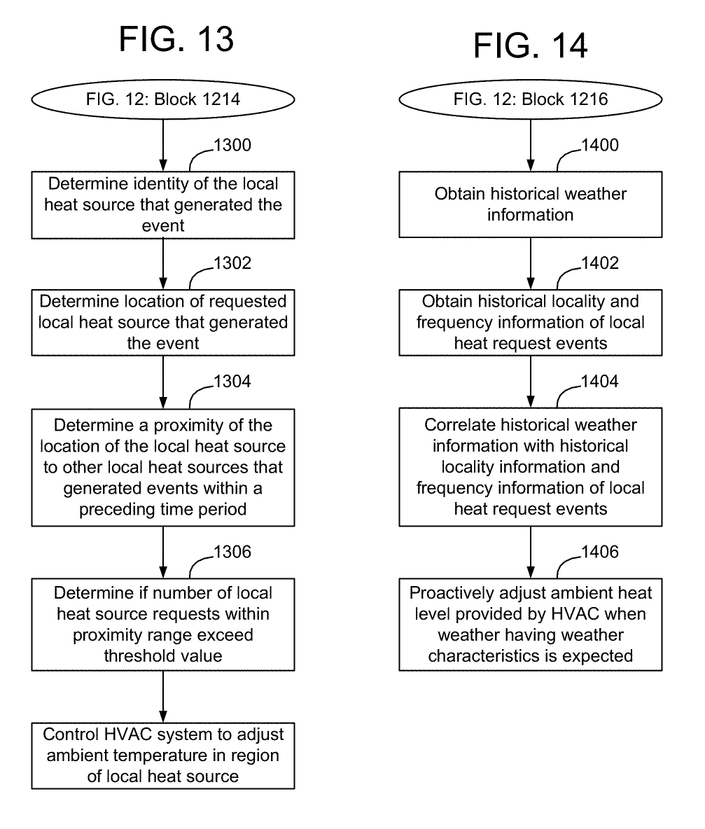

In some embodiments, the local heat request event is processed in block 1212, for example to identify patterns of local heat request events and reactively adjust the HVAC settings in block 1214. In some embodiments, as shown in FIG. 13, reactively adjusting the HVAC settings may include determining an identity of the networked local heating source 110 that generated the local heat request event in block 1300, determining a location of the networked local heating source 110 that generated the local heat request event in block 1302, determining a proximity of the location of the networked local heating source 110 to other networked local heating sources 110 that generated events within a preceding time period in block 1304, and determining if a number of local heat source requests, which are from networked local heating sources 110 within a proximity range, exceed a threshold value in block 1306. A proximity range may be based on determination of whether local heat source requests originate in the same region 141 of the workplace 100 as described in connection with FIG. 5, or using another proximity determination method.

In some embodiments, the system may also proactively adjust the ambient temperature in block 1216, which is described in greater detail with respect to FIG. 14. For example, a history of local heat request events and current or expected weather conditions may be used to proactively adjust the building HVAC system. In some embodiments, as shown in FIG. 14 proactively adjusting the ambient temperature may include obtaining historical weather information in block 1400, and obtaining historical locality and frequency information of local heat request events in block 1402. For example, weather information may be received from weather system 142 and stored in database 140. Alternatively, historical weather information may be received from weather system 142. The location information and frequency information of local heat request events may be obtained, for example, from the database 140.

Historical weather information is correlated with location information and frequency information of local heat request events in block 1404. By correlating locality information and frequency information of the origins of local heat request events, patterns may be extracted to determine, for example, if increased numbers of local heat request events occur in particular regions 141 of the workplace 100 during particular types of weather. When patterns of this nature are detected, the HVAC system may be used to proactively adjust ambient heating in the region 141 when the particular type of weather is detected or expected in block 1406. For example, if an increased number of local heat request events occur in the north region 141A of the building when the prevailing wind is from the north, when a north wind is predicted the HVAC system may be tuned to proactively increase the temperature slightly on the north side of the building to minimize or reduce the number of local heat request events generated in that region 141A of the workspace 100. Other weather conditions that might be relevant include sunshine from a particular direction, time of day, accumulation of snow or ice on particular parts of the building, and other physical indicia that may affect local temperature within particular areas of the building.

FIG. 15 is an electrical circuit diagram of an example system of networked local heating in accordance with some embodiments of the present disclosure. FIG. 15 shows an example workspace 100 including a number of networked local heating sources 110 that have been electrically interconnected to three dedicated circuits 162A, 162B, 162C. Each electrical circuit 162 provides power to fourteen networked local heating sources 110. However, in general a workspace may include any number of circuits, each circuit having any number of networked local heating sources 110.

In some embodiments, when a networked local heating source 110 is activated, the networked local heating source turns on a 200-watt lamp for a short duration time period, such as for five minutes, and then ramps down to eventually turn off. Electrical circuits in buildings in the US typically are designed to carry a maximum of 15 Amps of current at 110 Volts, which means that a maximum of 1800 watts are available on any given circuit 162 in a workspace 100. For practical purposes, and often for building code purposes, this limit is adjusted downward to 80% such that a given circuit has a maximum watt limit of on the order of 1440 watts. This means that a circuit dedicated to providing electrical power to networked local heating sources 110 may provide power to at most 6 or 7 active networked local heating sources 110.

In some implementations it may be feasible to provide a dedicated electrical circuit 162 to each groups of 6 or 7 networked local heating sources 110. However, since the networked local heating sources 110 are on for limited durations, it may be expected that not all networked local heating sources 110 will need to be on at the same time.

FIG. 16 is a flow chart of an example method of networked local heating in accordance with some embodiments of the present disclosure. As shown in FIG. 16, when a request is received to activate a networked local heating source 110 in block 1600, an identity of a requesting device is determined in block 1602. A determination is then made as to which circuit contains the requesting device in block 1604, and the load on the identified circuit is determined in block 1606. Determination of the load on the identified circuit 1606 may be implemented by determining which other networked local heating sources 110 on that circuit are currently actively generating heat. In some embodiments, determining the load on the identified circuit may be performed by the local heat source management system 132. In some embodiments, determining the load on the identified circuit may be performed by the networked local heating sources 110 by listening on the network 138 for requests for local heat to other networked local heating sources 110.

A determination is then made as to whether activation of the networked local heating source 110 would overload the circuit in block 1608. If activation of the networked local heating source 110 would not overload the circuit (e.g., a determination of “no” in block 1608), the networked local heating source 110 is activated to provide heat to the requesting individual in block 1610. If the determination is made that activation of the networked local heating source 110 would overload the circuit (e.g., a determination of “yes” in block 1608), the request is denied in block 1612 or, alternatively, one of the other currently active networked local heating sources 110 may be turned off in block 1614 to provide capacity on the circuit 162 to be able to supply electrical power to satisfy the more recent request for local heating. Optionally, instead of turning off one of the other currently active networked local heating sources 110, the power level of one or more currently active networked local heating sources may be reduced or one or more of the currently active networked local heating sources 110 may be commanded to enter its cool-off period 1106 during which the power is ramped down as shown in FIGS. 11A-11C.

As noted above in connection with FIG. 4, in some embodiments, the local heat source management system 132 maintains a database 140 containing information about networked local heating sources 110 and activity information about usage of the networked local heating sources 110. FIG. 17 is an example database entry in accordance with some embodiments of the present disclosure. As shown in FIG. 17, in some embodiments, the database 140 correlates information about the networked local heating source ID 1700, the networked local heating source location 1710, the region or regions 141 of the workspace 100 where the networked local heating source 110 is located 1720, the circuit ID 1730 of the circuit that is configured to supply power to the networked local heating source 110, and a log of usage data 1740 indicating when the networked local heating source 110 has been activated.

Using information stored in database 140, the local heat source management system 132 may determine how many times a particular networked local heating source 110 has been activated within a preceding time interval, so that it is possible to assign and enforce a usage quota to limit the frequency or total number of activations of a given networked local heating source. Likewise, the usage data 1740 along with location data 1710 and/or region data 1720 allows the local heat source management system 132 to correlate networked local heating source 110 activation data with weather as discussed above. Additionally, the circuit ID information 1730 allows the local heat source management system to limit the number of simultaneously active networked local heating sources on a given circuit. This enables a larger number of networked local heating sources 110 to be connected to the same circuit 162 to reduce overall installation cost, while likewise preventing against an overcurrent condition on the circuit 162.

In some embodiments, the target area 126 has an area that is on the order of 1 m². In other embodiments, the networked local heating sources 110 are designed to further limit radiative heating to just key parts of the occupant's body, and may be further limited to just body regions of exposed skin for maximum physiological stimulation. For example, if the light source is designed to have adjustable beam patterns, an imaging device such as camera 128 may be used to target overall body silhouette outlines. Likewise, the adjustable beam pattern might be aimed to target areas of exposed skin and adjust the application of heat accordingly—perhaps lower if there are sufficient exposed areas which would be efficiently heated and higher if most area is covered. Heat sources that may be variable in spatial distribution might include fixed position light sources with adjustable lenses or mirrors, arrays of multiple fixed position light sources that may be selectively powered on to tailor overall emission profiles to the spatial specification, or a light source or array of light sources that are not fixed in position and which may swivel in place to selectively address specific targets.

In some embodiments, image analysis is also used to infer thermal comfort and trigger operation of the heat sources automatically. For example, video analysis of occupant posture or shivering may be used to infer the level of thermal comfort of the occupant. Likewise, thermal imaging of skin temperature distribution may be used to assess thermal comfort.

In some embodiments, the ambient lighting is changed in coordination with heat requests. For example, the lighting may be brightened, or color temperature lowered to provide a visually “warmer” environment, or to provide better visual matching to a heat source, which is likely to have a low Correlated Color Temperature (CCT) appearance.

In addition to providing occupants with a mechanism for instant relief, the actuation of heat by an occupant is logged as data which may be used to infer present thermal conditions in a space. Because the occupant may expect instant gratification in the form of heat delivered, this feedback collection method is likely to be more responsive and complete than that obtained from traditional methods such as submitting facilities tickets. Moreover, the feedback reflects actual human sensing of environmental comfort rather than inferred comfort based on hardware sensors. Physical data of temperature, humidity, air flow velocity, etc., may be considered to be first-order predictors of occupant comfort, but human metabolic and psychological factors may be equally important intangible factors. Heat requests provide information on these intangible factors and remove the need for inference based only on the first order predictors. Further supplying instant heat to the occupant in response to each request may result in a constant dialog with the occupant which the occupant is not likely to become easily frustrated or fatigued with, because the occupant is equitably compensated with heat.

In some embodiments, the heat request data is correlated with data from occupancy/motion sensors, environmental sensors (temperature, humidity, light level) weather reports, and other ambient information, to help understand the thermal characteristics of the building in relation to the thermal preferences of the occupants.

Further, in some embodiments, the usage log includes an identity of the occupant. For example, in a co-work environment or in a workplace without assigned workstations, a given employee may work at a different desk each day. Keeping track of how often the employee activates the networked local heating source 110 enables the system of networked local heating to proactively adjust ambient conditions in regions of the workspace based on the occupants' preferences inferred through the current set of occupants' previous usage history.

In some embodiments, the local heat source management system 132 employs machine learning algorithms to proactively predict occupant heat requests and therefore automate the operation of each occupant's radiative heating devices. For example, a historical pattern of heat requests from a particular occupant after a period of sedentary activity, at a particular time in the afternoon, during particular weather conditions, or in connection with certain ambient conditions, may be detected by the learning algorithm and used to proactively activate one of the networked local heating sources 110 to provide heat to the occupant without requiring the occupant to request activation of the networked local heating source 110.

In addition to automating operation of the networked local heating sources 110, machine learning and/or data analytics may be used to automate the operation of the building HVAC system. For example, setpoints for different regions 141 of the workspace 100 may be determined based on occupant activity, occupant preferences, environmental conditions, and weather forecasts. Occupant feedback, for example in comparison with historical data, may also quickly call attention to HVAC equipment issues, such as failure of a heater boiler or circulation fan.

In some embodiments, occupant feedback in terms of heat requests (or not) allows for new metrics to be defined and used for evaluation of occupant comfort, characterization of occupant preferences, evaluation of HVAC efficacy, and evaluation of the cost of operation of the networked local heating sources 110 vs. HVAC costs. Example metrics may include:
occupant comfort, based on the frequency of heat requests by a person or per person in a group of persons;
occupant preferences, based on the number of heat requests made per occupancy hour as a function of ambient temperature; and
HVAC efficacy, based on the occupant comfort metric normalized by energy used, which may be used to highlight variations in the occupant comfort metric throughout a workspace 100.

Although some embodiments have been discussed in which networked local heating is provided on demand, in other embodiments cooling is also available on-demand. For example, in some embodiments, networked local cooling is implemented using networked local fans mounted to provide directional air flow toward an occupant of a target area 126. In some embodiments, requests for local cooling through activation of the networked local fans is communicated to local heat source management system 132 in a manner similar to requests for activation of networked local heating sources 110. By monitoring requests for local cooling, the local heat source management system 132 may also infer when the temperature in regions of the workspace is too high.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more non-transitory tangible computer-readable storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Read Only Memory (ROM), cache, optical or magnetic disk, Redundant Array of Independent Disks (RAID), floppy drive, CD, DVD, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the Internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s), personal digital assistant(s) (PDA(s)), handheld device(s) such as cellular telephone(s) or smart cellphone(s), laptop(s), tablet or handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Implementations of the systems and methods described above comprise computer components and computer-implemented processes that will be apparent to those skilled in the art. Furthermore, it should be understood by one of skill in the art that the computer-executable instructions may be executed on a variety of processors such as, for example, microprocessors, digital signal processors, gate arrays, etc. In addition, the instructions may be implemented in a high-level procedural and/or object-oriented programming language, and/or in assembly/machine language. For ease of exposition, not every element of the systems and methods described above is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the disclosure.

The following reference numerals are used in the drawings:

100 workspace

110 networked local heating sources

112 individual office

114 cubicle

116 conference room

118 duct outlets

120 chair

122 desk

124 directional IR radiation beam pattern

126 target area

128 camera

130 system of networked local heating

132 local heat source management system

134 networked heat controller

136 local heat source controller

138 network

140 database

141 region

142 weather system

150 communication module

152 power control

154 IR radiation source

156 IR radiation focusing system

158 IR heat module

160 building control system

162 circuit

Although the methods and systems have been described relative to specific embodiments thereof, they are not so limited. Many modifications and variations may become apparent in light of the above teachings. Many additional changes in the details, materials, and arrangement of parts, herein described and illustrated, may be made by those skilled in the art. A number of implementations have been described. Nevertheless, it will be understood that additional modifications may be made without departing from the scope of the inventive concepts described herein, and, accordingly, other implementations are within the scope of the following claims.

What is claimed is:

1. A system of networked local heating, comprising:
a plurality of networked local heating sources, wherein each networked local heating source comprises:
a directional infrared (IR) radiation heat source configured to output directional IR radiation toward a remotely located target area; and
a local heat source controller configured to activate the directional IP radiation heat source to output the directional IR radiation toward the remotely located target area during short duration radiative heat events in response to heat event requests; and
a local heat source management system configured to log heat event requests from each of the local heat source controllers.

2. The system of claim 1, wherein the local heat source management system is further configured to apply a quota to each of the plurality of networked local heating sources to prevent activation of each of the plurality of networked local heating sources more than the quota number of times during a given time interval.

3. The system of claim 1, wherein the local heat source management system is further configured to send an instruction to a building control system to request an adjustment to an ambient temperature in a region encompassing a subset of the plurality of networked local heating sources when a number of heat event requests from the subset of networked local heating sources exceeds a threshold value.

4. The system of claim 1, wherein the local heat source management system is further configured to correlate requests for activation of a subset of the plurality of networked local heating sources located within a region of an indoor environment with weather conditions outside of the indoor environment.

5. The system of claim 4, wherein the local heat source management system is further configured to:
obtain information about anticipated or detected weather conditions outside of the indoor environment; and
request an adjustment to an ambient temperature in the region encompassing the subset of networked local heating sources when a historical number of requests from the subset of networked local heating sources within the region exceeded a threshold value during previous periods of similar weather conditions.

6. The system of claim 1, wherein each of the plurality of networked local heating sources is configured to output a directional IR radiation beam pattern toward at least one respective target area.

7. The system of claim 6, wherein one or more of the plurality of networked local heating sources are configured to steer the directional IR radiation beam pattern toward a plurality of respective target areas.

8. The system of claim 7, further comprising a camera to obtain at least one image of the plurality of respective target areas, and wherein each of the one or more networked local heating sources is configured to use the at least one image to determine which of the respective target areas is occupied by a person and to steer the directional IR radiation beam pattern toward the respective target areas that are occupied by the person.

9. The system of claim 1, further comprising a camera to obtain an image of a first target area associated with a first networked local heating source, and wherein the local heat source management system is further configured to:
detect whether a person is present in the first target area based on the image; and
control the first networked local heating source based on whether the person is present in the first target area.

10. The system of claim 1, wherein one or more of the plurality of networked local heating sources further comprises at least one of a communication module, a power control module, an IR radiation source, and an IR radiation focusing system.

11. The system of claim 10, wherein the communication module is configured to communicate with the local heat source controller and the local heat source management system via one or more wireless communication networks.

12. The system of claim 10, wherein the power control module selectively supplies power to the directional IR radiation heat source under the control of the communication module.

13. The system of claim 10, wherein the directional IR radiation heat source is ceiling mounted.

14. The system of claim 1, wherein a user inputs the heat event request to the local heat source controller.

15. A method of networked local heating, comprising:
receiving, at a networked local heating source, a request to activate the networked local heating source, wherein the networked local heating source comprises an infrared (IR) radiation heat source that is controllable by a local heat source controller to output IR radiation during short duration heat events;
communicating, by the networked local heating source, information about the request to a local heat source management system configured to log heat event requests from the local heat source controller; and
activating, by the networked local heating source in response to the request, the IR radiation heat source to provide a directional IR radiation beam pattern toward a remotely located target area in an indoor environment.

16. The method of claim 15, further comprising applying a quota, by the local heat source management system, to prevent activation of the networked local heating source more than the quota number of times during a given time interval.

17. The method of claim 15, further comprising sending an instruction, by the local heat source management system to a building control system, to request an adjustment to an ambient temperature in a region encompassing the networked local heating source when a number of requests from a plurality of networked local heating sources within the region exceeds a threshold value.

18. The method of claim 15, further comprising correlating, by the local heat source management system, requests for activation of a set of networked local heating sources located within a region of the indoor environment with weather conditions outside of the indoor environment.

19. The method of claim 18, further comprising:
obtaining, by the local heat source management system, information about anticipated or detected weather conditions outside of the indoor environment; and
requesting, by the local heat source management system, an adjustment to an ambient temperature in the region encompassing the set of networked local heating sources when a historical number of requests from the set of networked local heating sources within the region exceeded a threshold value during previous periods of similar weather conditions.

20. The method of claim 15, wherein activating the IR radiation heat source comprises outputting directional IR radiation at a first constant level for a first period of time and then ramping down a power level of the directional IR radiation over a second period of time.
